(19) United States
(12) Patent Application Publication
(10) Pub. No.: US 2023/0413085 A1
(43) Pub. Date: Dec. 21, 2023

(54) METHODS AND APPARATUS FOR DETERMINING UE APPROPRIATE STATES BY TRAFFIC TYPE DETECTION

(71) Applicant: MediaTek Inc., Hsinchu City (TW)

(72) Inventors: Zhen Zou, Beijing (CN); Jianwei Zhang, Beijing (CN); Nien-En Wu, Hsinchu City (TW); Po-Chung Hsiao, Hsinchu City (TW); Chih-Wei Chen Chen, Hsinchu City (TW); Jun Hu, Beijing (CN); Cheng-Yu Tsai, Hsinchu City (TW); HSIEN-WEN HU, Hsinchu City (TW)

(21) Appl. No.: 18/366,556

(22) Filed: Aug. 7, 2023

Related U.S. Application Data
(60) Provisional application No. 63/353,080, filed on Jun. 17, 2022.

(30) Foreign Application Priority Data
May 16, 2023 (CN) 202310551310.1

(51) Int. Cl. H04W 24/08; H04W 24/02; H04L 43/026

(52) U.S. Cl. CPC H04W 24/08; H04W 24/02; H04L 43/026

(57) ABSTRACT

Apparatus and methods are provided for determining UE appropriate states by traffic type detection. In one novel aspect, a UE traffic type is determined based on a plurality of UE metrics. One or more UE settings for transmission and/or reception are adjusted based on the determined UE traffic type. The UE traffic type determination procedure and UE configuration adjustment procedure are iterated to balance performance and power saving. In one embodiment, the UE collects a plurality of UE metrics for a UE traffic profile matrix, wherein the UE traffic profile matrix is used to determine a plurality of UE traffic types based on the plurality of UE metrics. The UE determines a real-time UE traffic type based on the collected UE metrics using the UE traffic profile matrix and adjusts a set of UE configurations based on the UE traffic type when one or more predefined conditions are met.

### CROSS REFERENCE TO RELATED APPLICATIONS

This application claims priority under 35 U.S.C. § 119 from Chinese Application Number 202310551310.1, titled “METHODS FOR DETERMINING AR FILTER COEFFICIENT AND TIMES OF SYNCHRONIZATION,” filed on May 16, 2023. This application claims priority under 35 U.S.C. § 119 from U.S. Provisional Application No. 63/353,080 entitled “METHODS FOR DETERMINING UE APPROPRIATE STATES BY TRAFFIC TYPE DETECTION,” filed on Jun. 17, 2022. The disclosure of each of the foregoing documents is incorporated herein by reference.

### TECHNICAL FIELD

The disclosed embodiments relate generally to wireless communication, and, more particularly, to determining UE appropriate states by traffic type detection.

### BACKGROUND

With the development and availability of 5G fast expanding worldwide, the demand of wireless data traffic is continually increasing. The requirement for high performance mobile devices as well as power efficiency becomes more and more important. In the existing solutions, the control and switch of UE's characteristics and features that impact on DL/UL performance and power consumption are independent of real-time traffic type and corresponding communication quality. This means that if a UE is undertaking a specific traffic type, the configuration of UE parameters and the switch of UE features may not be suitable for the balance of power consumption and DL/UL performance, which can result in extra power consumption or performance loss. For example, a UE that is undertaking a conversational traffic type (such as a voice call) may require a different configuration of UE parameters and a different switch of UE features than a UE that is undertaking a streaming traffic type (such as a video stream). If the UE parameters and UE features are not configured and switched appropriately for the traffic type, then the UE may consume more power or experience lower performance than it would if the parameters and features were configured and switched appropriately.

Improvements and enhancements are required to determine UE appropriate states based on traffic type detection.

### SUMMARY

Apparatus and methods are provided for determining UE appropriate states by traffic type detection. In one novel aspect, a UE traffic type is determined based on a plurality of UE metrics. One or more UE settings for transmission and/or reception are adjusted based on the determined UE traffic type. The UE traffic type determination procedure and UE configuration adjustment procedure are iterated to balance the UE performance and the power saving.

In one embodiment, the UE collects a plurality of UE metrics for a UE traffic profile matrix, wherein the UE traffic profile matrix is used to determine a plurality of UE traffic types based on the plurality of UE metrics. The UE determines a real-time UE traffic type based on the collected UE metrics using the UE traffic profile matrix and adjusts a set of UE configurations based on the UE traffic type when one or more predefined conditions are met. The UE monitors one or more communication quality metrics after adjusting the set of UE configurations. The UE iterates the determining traffic type procedure and the adjusting UE configurations procedure.

In one embodiment, the plurality of UE metrics includes one or more elements comprising an uplink downlink slot duty ratio, a buffer status report, a throughput, a block error rate, and a UE modulation and coding scheme. In another embodiment, the UE metrics includes elements from one or more sources comprising one or more lower layer reports, one or more high layer configuration, and application processor assisted information. In one embodiment, the set of UE configuration includes one or more TX settings comprising a maximum power reduction (MPR) value, a power amplifier (PA) voltage, a TX antenna number, Transmission antenna selection, Transmission path selection, and a switch setting of a crest factor reduction (CFR)/digital pre-distortion (DPD)/envelope tracking (ET) switch. In another embodiment, the set of UE configuration includes one or more RX settings comprising an RX antenna number, receiver mode, coverage enhancement (CE) mode, the number of multiple input multiple output (MIMO) search path, dynamic voltage and frequency scaling (DVFS), and reception antenna selection. In one embodiment, the RX configurations are adjusted based on both the UL and DL metrics and configurations. The TX configurations are adjusted based on both the UL and DL metrics and configurations. In one embodiment, the one or more predefined conditions include a power-saving trigger when one or more communication quality metrics being higher than one or more predefined corresponding power-saving thresholds, and a reverting trigger when one or more communication quality metrics being lower than one or more predefined corresponding reverting thresholds. The UE adjusts the set of UE configurations to preconfigured settings based on the traffic type when the power-saving trigger condition is met. In one embodiment, the power-saving trigger is the communication quality of the UE is higher than a predefined trigger threshold. In another embodiment, the UE recover to a previous setting after adjusting the configuration when the UE communication quality is lower than a predefined revert threshold.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that adjusts the UE configuration based on a traffic type determined by a plurality of metrics and UE configurations in accordance with embodiments of the current invention.

FIG. 2 illustrates an exemplary top level diagram for determining the UE appropriate state based on traffic type in accordance with embodiments of the current invention.

FIG. 3 illustrates exemplary diagrams for determining a real-time UE traffic type based on a plurality of UE metrics in accordance with embodiments of the current invention.

FIG. 4 illustrates exemplary diagrams for adjusting one or more TX and/or RX parameters based on the real-time UE traffic type in accordance with embodiments of the current invention.

FIG. 5 illustrates an exemplary flow diagram for the procedure of adjusting UE configurations based on the UE traffic type, which is determined by a plurality of UE metrics in accordance with embodiments of the current invention.

FIG. 6 illustrates an exemplary flow chart for determination of the UE appropriate state based on the UE traffic type in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system.

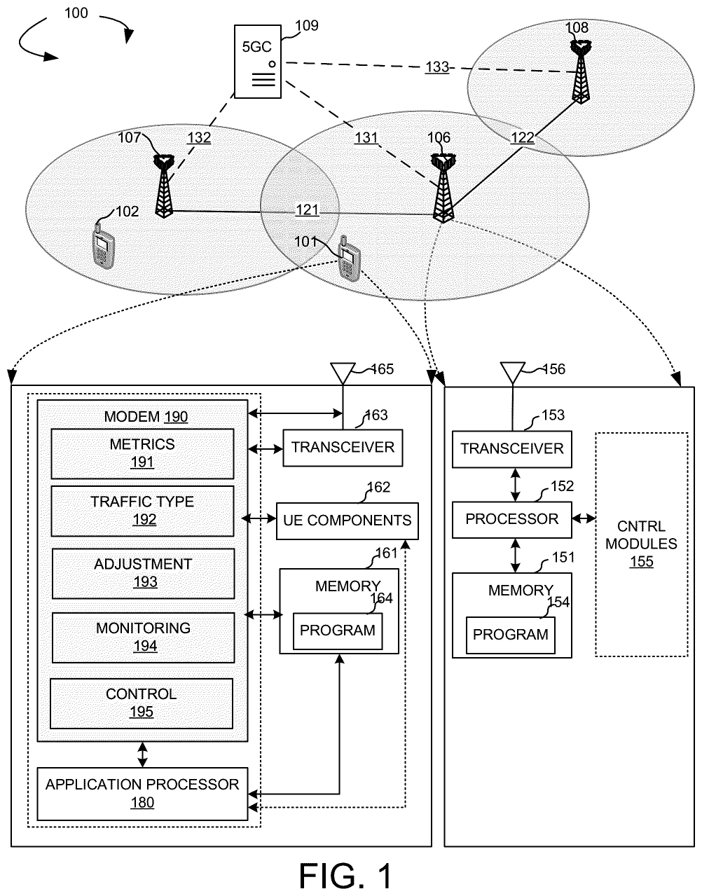

FIG. 1 is a schematic system diagram illustrating an exemplary wireless network that adjusts the UE configuration based on a traffic type determined by a plurality of metrics and UE configurations in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 106, gNB 107 and gNB 108 are base stations in the wireless network, the serving area of which may or may not overlap with each other. As an example, user equipment (UE) 101 or mobile station 101 is in the serving area covered by gNB 106 and gNB 107. As an example, UE 101 or mobile station 101 is only in the service area of gNB 106 and connected with gNB 106. UE 102 or mobile station 102 is only in the service area of gNB 107 and connected with gNB 107. gNB 106 is connected with gNB 107 via Xn interface 121. gNB 106 is connected with gNB 108 via Xn interface 122. A 5G network entity 109 connects with gNB 106, 107, and 108 via NG connection 131, 132, and 133, respectively.

In one novel aspect, a UE traffic type is determined based on a plurality of real-time UE metrics and configurations. For example, UE 101 collects multiple metrics, including active UL/DL slot duty ratio, buffer status report (BSR), and modulation and coding scheme (MCS). These metrics can be used to estimate the UE's undertaking scenarios. There are many mobile device components for uplink transmission and downlink reception. The parameters/configurations of these UE components can be adjusted. By adjusting the parameters/configurations of the UE components, it is possible to improve the performance of the UE in different undertaking scenarios. For example, in a high-traffic scenario, the UE can be configured to transmit at a higher power and use a higher-order modulation scheme. This will improve the data rate, but it will also consume more power. In a low-traffic scenario, the UE can be configured to transmit at a lower power and use a lower-order modulation scheme. This will save power, but it will also reduce the data rate. The UE can also adjust its configuration based on the quality of the signal. In a poor-signal scenario, the UE can be configured to use a more robust modulation scheme and a higher transmission power. This will improve the reliability of the data reception, but it will also consume more power. In a good-signal scenario, the UE can be configured to use a less robust modulation scheme and a lower transmission power. This will save power, but it may also reduce the data rate. When the UE traffic type, such as high loading/low loading, or traffic priority or performance quality are taken alone to adjust the TX/RX configuration, the performance and/or the efficiency of the UE is not optimized.

In another embodiment, the scenarios further include normal scenario, low power scenario, extreme low power scenario, enhanced performance scenario and specific scenarios indicated/defined/determined by thermal/In Device Coexistence (IDC)/(power density, PD) indicator. In the normal scenario, the communication performance/quality should meet adjacent channel leakage ratio (ACLR) and/or error vector magnitude (EVM) requirements. UE may transmit data as same as a legacy procedure without a trigger for low power or performance boost. In the low power scenario, the transmission power may reduce with a regular step in which the ACLR and EVM quality may suffer to a thin decrease and BLER should keep in the normal/appropriate range. In the extreme low power scenario, the transmission power may reduce with an extreme step in which BLER may suffer to a certain extent descending and users have a worse experience. In the enhanced performance scenario, better performance requirement should be guaranteed by boosting power.

In one novel aspect, a new UE traffic type is determined. The UE traffic type considers a holistic view of a plurality of UE metrics and the real-time UE configurations. In one embodiment, the UE traffic profile matrix is used to determine the real time UE traffic type. The TX/RX parameters are adjusted based on the real-time determined UE traffic type. The procedure is iterated by monitoring the UE performance after the adjustment.

FIG. 1 further illustrates simplified block diagrams of a base station and a mobile device/UE that supports measurement weight factors. gNB 106 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 106. gNB 106 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RF transceiver circuit 163, coupled with the antenna 165, receives RF signals from antenna 165, converts them to intermediate frequency (IF) or baseband signals, and sends them to modem 190. RF transceiver 163 also converts received IF or baseband signals from modem 190, converts them to RF signals, and sends out to antenna 165. Modem 190 processes the received baseband signals. In one embodiment, modem 190 invokes different functional modules to perform features in UE 101. Application processor (AP) 180 performs application control functions and interacts with modem 190. In one embodiment, all or part of the functions are performed by the AP 180. Other UE components 162 interacts with modem 190 and/or AP 180. Memory 161 stores program instructions and data 164 to control the operations of UE 101. Antenna 165 sends uplink transmission and receives downlink transmissions to/from antenna 156 of gNB 106. In some embodiments of the invention, the modem 190 and the application processor 180 may be designed as discrete chips with some buses or hardware interfaces coupled there between, or they may be integrated into a combo chip (i.e., a system on chip (SOC)), and the invention should not be limited thereto.

The UE also includes a set of control modules that carry out functional tasks. These control modules can be implemented by circuits, software, firmware, or a combination of them. In one embodiment, control modules 191-195 are invoked by modem 190 (as shown). In another embodiment, some control modules of 191-195 are invoked by AP 180 (not shown). The control modules 191-195 and the functions can be performed by modem 190, or by AP 180, or by both modem 190 and AP 180. A metrics module 191 collects a plurality of UE metrics for a UE traffic profile matrix, wherein the UE traffic profile matrix determines a plurality of UE traffic types based on the plurality of UE metrics. A traffic type module 192 determines a UE traffic type based on the collected UE metrics using the UE traffic profile matrix. An adjustment module 193 adjusts a set of UE configurations based on the UE traffic type when one or more predefined conditions are met. A monitoring module 194 monitors one or more communication quality metrics after adjusting the set of UE configurations. A control module 195 iterates the determining traffic type procedure and the adjusting UE configurations procedure.

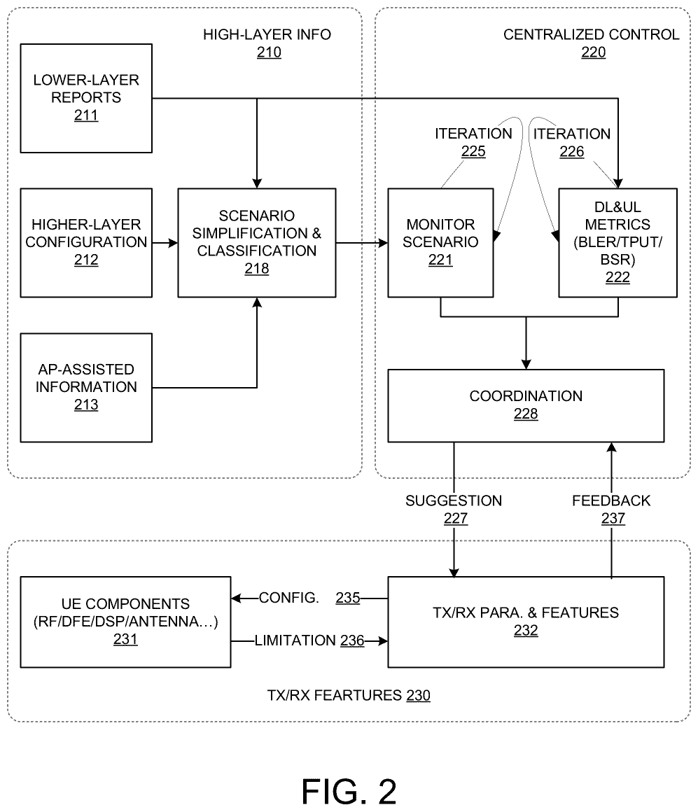

FIG. 2 illustrates an exemplary top level diagram for determining the UE appropriate state based on traffic type in accordance with embodiments of the current invention. In one novel aspect, the UE collects real-time metrics and UE configurations. The UE determines a real-time traffic type based on the collected information. The UE selects a set of adjusted parameters and/or features and updates corresponding UE components. The UE monitors the real-time metrics to determine the UE performance and evaluate the UE power consumption after the adjustment. The UE reiterates the procedures of updating the traffic type based on the collected information and adjusting the UE configurations based on the traffic type. In a top-level view, the UE gets high-layer information 210, such as the type of traffic and the QoS requirements and feeds it to the centralized control 220. Centralized control 220 determines the traffic type and selects updated parameters and/or configurations for the TX and/or RX features 230. These updated parameters and/or configurations are then fed back to centralized control 220, which uses them to iterate the determining traffic type procedure and the adjusting UE configuration procedure. In one embodiment, the UE collects a plurality of real-time UE metrics and one or more UE configurations. The UE collects the metrics from different sources including the lower-layer reports 211, such as reports from digital signal processor (DSP); the higher-layer configuration 212, such as configuration information obtained from RRC message, and the AP-assisted information 213. In one embodiment, UE metrics from other sources are dynamically configured. At procedure 218, the UE performs scenario simplification and/or classification procedure with all the source inputs. High-layer information 210, through procedure 218 with scenario simplification generates UE real-time metrics and scenario information as outputs. In one embodiment, these metrics collected are fed into a UE traffic profile matrix. In another embodiment, other algorithms are implemented to generalize a traffic type based on the collected UE metrics. Centralized control 220 performs monitoring scenario procedure 221 and collecting performance information procedure 222, including DL&UL block error rate (BLER), throughput (Tput) and buffer status reports. I

In one embodiment, the monitoring scenario procedure 221 and the metrics collecting procedure 222 perform iteration 225 and 226, respectively. The UE monitors one or more plurality of communication quality metrics and UE configurations after adjusting one or more UE configurations to determine if the UE is in the appropriate state that balances the performance and the power consumption. In one embodiment, the one or more communication quality metrics include block error rate (BLER), signal-to-noise ratio (SNR), transmission power, adjacent channel leakage ratio (ACLR) and/or error vector magnitude (EVM). Iterations 225 and 226 also trigger new adjustment and/or reverting procedures.

In one embodiment, collecting performance information procedure 222 gets the inputs from low-layer reports 211. A coordination procedure 228 receives inputs from monitoring scenario procedure 221 and collecting performance information procedure 222. The UE real-time traffic type takes into account traditional traffic type information, such as heavy loading/light loading, voice-like traffic type, traffic priority, and throughput. In addition, the UE real-time traffic type is further based on the UE real-time metrics collected through sources 211, 212 and 213. Coordination procedure 228 adjust one or more UE configurations and sends suggestions (227) to TX/RX parameter and features process 232. TX/RX parameter and features process 232, at step 235, configures one or more UE components 231 based on the adjusted UE parameters and/or features. The one or more UE components 231 indicates to TX parameter and features process 232, at step 236, of component limitation such that the one or more adjustments are within the range. Feedback 237 is sent to coordination procedure 228 as an input to determine the adjustment for one or more UE configurations. In one embodiment, the one or more UE components 231 include RF transceiver, Digital frond end (DFE), antenna and so on.

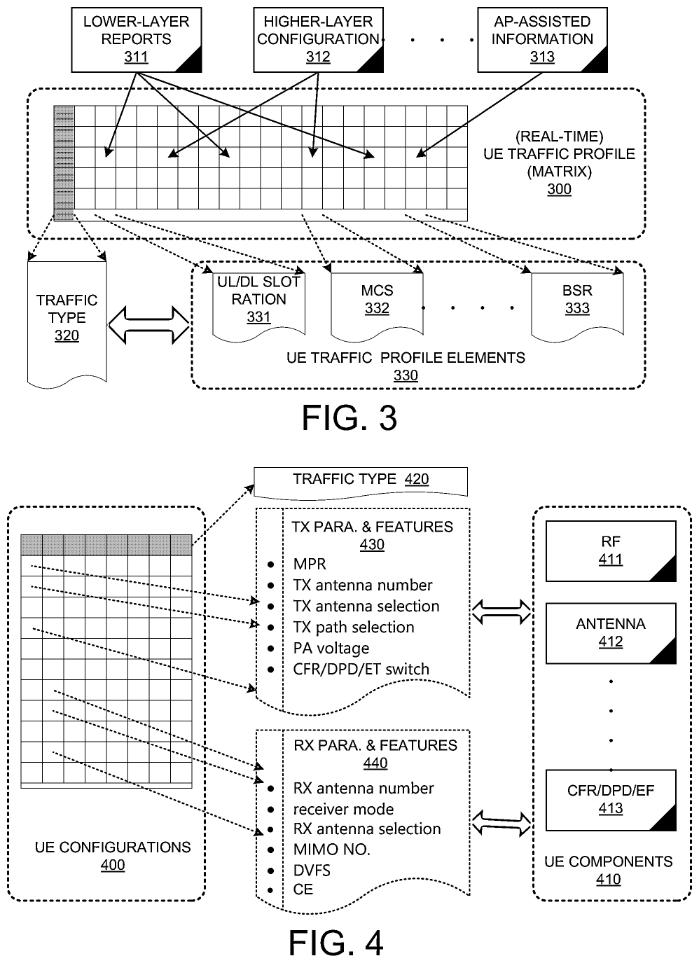

FIG. 3 illustrates exemplary diagrams for determining a real-time UE traffic type based on a plurality of UE metrics in accordance with embodiments of the current invention. In one embodiment, the UE traffic profile is used to determine the UE traffic type based on a plurality of the UE metrics. In one embodiment, a UE traffic profile matrix is generated to determine the UE traffic type. The UE traffic type considers a plurality of UE metrics in real-time. These UE metrics not only include the heavy loading/low loading, traffic priority, and/or throughput, but also UE metrics from different sources, including low-layer report 311, high-layer configuration 312, and/or AP-assisted information 313. In one embodiment, a UE traffic profile matrix 300 is used to determine the UE traffic type. The UE traffic profile matrix includes a column of a plurality of UE traffic type 320. The matrix includes one column for the UE traffic type 320, and columns for UE metrics and UE configurations, and the UE traffic profile elements 330. The UE metrics are measurements that are collected from the UE, such as the signal strength, the data rate, and the packet loss rate. For example, UE traffic profile matrix includes column 331 of UL/DL slot ratio, column 332 of MCS, and column 333 of BSR. In one embodiment, each element of a UE traffic profile matrix 300 is a threshold or a range for the specific corresponding UE metric. The UE collects real-time UE metrics and determines the UE traffic type using the UE traffic profile matrix. In other embodiments, other data structures may be used to determine the UE traffic type. In other embodiments, each UE metric may be weighted, and the weight can be predefined or dynamically updated.

FIG. 4 illustrates exemplary diagrams for adjusting one or more TX and/or RX parameters based on the real-time UE traffic type in accordance with embodiments of the current invention. In one embodiment, a set of UE configurations are adjusted based on the UE traffic type when one or more conditions are met. In one embodiment, a UE configuration 400 is used to adjust the UE configurations. UE configuration 400 includes TX parameters and features 430, and RX parameters and features 440. In one embodiment, the UE adjusts one or more UE settings for the TX parameters based on the determined traffic type 420 or adjusts one or more UE setting for the RX parameters based on the determined traffic type 420 or adjusts both the RX and TX settings. In one embodiment, the UE adjusts the RX settings based on both the UL and DL metrics and/or configurations. The UE adjusts the RX settings based on both the UL and DL metrics configurations. In one embodiment, the TX settings comprise at least one of MPR value, PA voltage, a TX antenna number, TX antenna selection, TX path selection, and a switch setting of CFR/DPD/ET switch. In another embodiment, the RX settings comprise at least one of an RX antenna number, receiver mode, CE mode, the number of MIMO search path, DVFS, and reception antenna selection. The adjusted RX and/or TX parameters are applied to one or more UE components 410, which includes RF transceiver 411, antenna 412, and a component for crest factor reduction (CFR)/digital pre-distortion (DPD) envelope tracking (ET) switch.

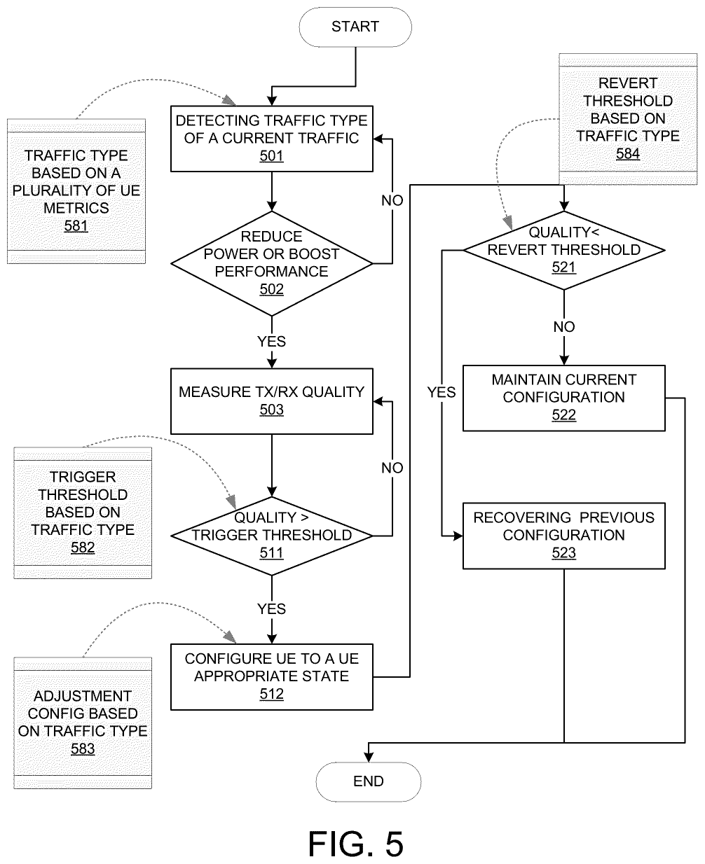

FIG. 5 illustrates an exemplary flow diagram for the procedure of adjusting UE configurations based on the UE traffic type, which is determined by a plurality of UE metrics in accordance with embodiments of the current invention. At step 501, the UE detects the UE traffic type of a current traffic. In one embodiment 581, the UE traffic type is determined based on a plurality of UE metrics. At step 502, the UE determines whether reducing power consumption or boosting UE performance is needed. If step 502 determines no, the UE moves back to step 501 and continues monitoring the UE metrics and updates the UE traffic type. If step 502 determines yes, the UE moves to step 503 and measures TX or RX or both communication quality. At step 511, the UE determines if the communication quality is greater than a predefined trigger threshold. In one embodiment 582, different trigger thresholds are configured/predefined based on the UE traffic type. In other embodiments, different trigger thresholds are configured/predefined based on one or more other factor with or without consideration of the UE traffic type. If step 511 determines no, the UE moves back to step 503 and continues monitoring the performance. If step 511 determines yes, in step 512, the UE is configured in a UE appropriate state. In one embodiment 583, the UE adjusts one or more UE RX and/or TX settings based on the UE traffic type. After adjusting the UE configurations, at step 521, the UE determines whether the UE performance quality is lower than a predefined revert threshold. In one embodiment 584, different revert thresholds are configured/predefined based on the UE traffic type. In other embodiments, different revert thresholds are configured/predefined based on one or more other factor with or without consideration of the UE traffic type. If step 521 determines no, the UE, at step 522 maintains the current adjusted configuration. If step 521 determines yes, the UE, at step 523, recovers to the previous configuration.

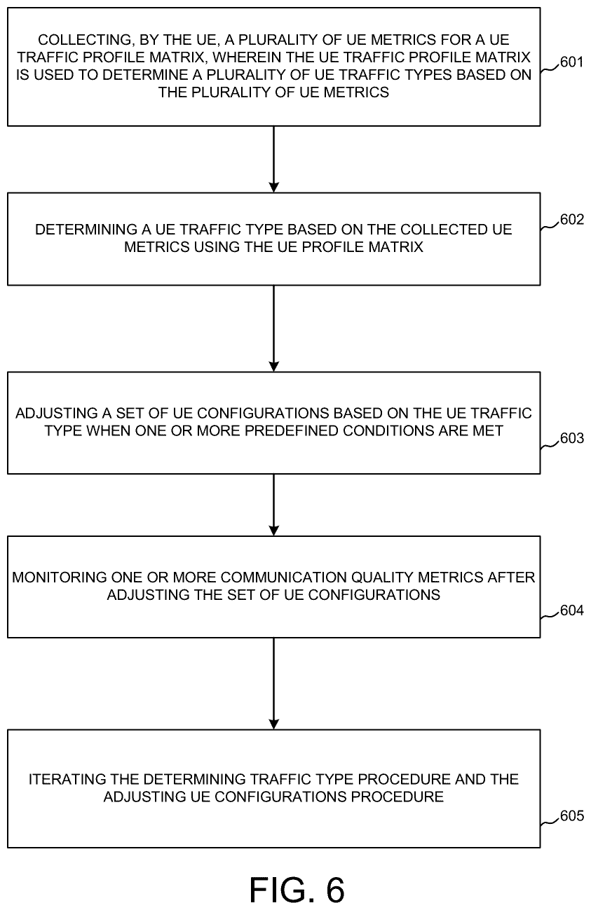

FIG. 6 illustrates an exemplary flow chart for determination of the UE appropriate state based on the UE traffic type in accordance with embodiments of the current invention. At step 601, the UE collects a plurality of UE metrics for a UE traffic profile matrix, wherein the UE traffic profile matrix is used to determine a plurality of UE traffic types based on the plurality of UE metrics. At step 602, the UE determines a UE traffic type based on the collected UE metrics using the UE traffic profile matrix. At step 603, the UE adjusts a set of UE configurations based on the UE traffic type when one or more predefined conditions are met. At step 604, the UE monitors one or more communication quality metrics after adjusting the set of UE configurations. At step 605, the UE iterates the determining traffic type procedure and the adjusting UE configurations procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) in a wireless network comprising:
collecting, by the UE, a plurality of UE metrics for a UE traffic profile matrix, wherein the UE traffic profile matrix is used to determine a plurality of UE traffic types based on the plurality of UE metrics;
determining a UE traffic type based on the collected UE metrics using the UE traffic profile matrix;
adjusting a set of UE configurations based on the UE traffic type when one or more predefined conditions are met;
monitoring one or more communication quality metrics after adjusting the set of UE configurations; and
iterating the determining traffic type procedure and the adjusting UE configurations procedure.

2. The method of claim 1, wherein the plurality of UE metrics includes one or more elements comprising a uplink/downlink slot duty ratio, a buffer status report, a throughput, a block error rate, and a UE modulation and coding scheme.

3. The method of claim 1, wherein the plurality of UE metrics includes elements from one or more sources comprising one or more lower layer reports, one or more high layer configuration, and application processor-assisted information.

4. The method of claim 1, wherein the plurality of UE metrics includes both uplink (UL) metrics and downlink (DL) metrics.

5. The method of claim 4, wherein the set of UE configuration includes one or more TX settings comprising a maximum power reduction (MPR) value, a power amplifier (PA) voltage, a TX antenna number, Transmission antenna selection, Transmission path selection, and a switch setting of a crest factor reduction (CFR), digital pre-distortion (DPD), envelope tracking (ET) switch.

6. The method of claim 4, wherein the set of UE configuration includes one or more RX settings comprising an RX antenna number, receiver mode, coverage enhancement (CE) mode, a number of multiple input and multiple output (MIMO) search path, dynamic voltage and frequency scaling (DVFS), and reception antenna selection.

7. The method of claim 1, wherein each traffic type is preconfigured with a set of corresponding predefined settings for the set of UE configurations.

8. The method of claim 1, wherein each traffic type is configured with corresponding predefined triggering thresholds to trigger the adjusting UE configurations procedure.

9. The method of claim 1, wherein the one or more predefined conditions comprises a power-saving trigger when the one or more communication quality metrics being higher than one or more predefined corresponding power-saving thresholds, and a reverting trigger when the one or more communication quality metrics being lower than one or more predefined corresponding reverting thresholds.

10. The method of claim 9, wherein the adjusting UE configurations procedure adjusts the set of UE configurations to a preconfigured settings based on the UE traffic type when the power-saving trigger condition is met.

11. The method of claim 1, wherein the one or more communication quality metrics include block error rate (BLER), signal-to-noise ratio (SNR), transmission power, adjacent channel leakage ratio (ACLR) or error vector magnitude (EVM).

12. A user equipment (UE), comprising:
a transceiver that transmits and receives radio frequency (RF) signal in a wireless network;
a metrics module that collects a plurality of UE metrics for a UE traffic profile matrix, wherein the UE traffic profile matrix is used to determine a plurality of UE traffic types based on the plurality of UE metrics;
a traffic type module that determines a UE traffic type based on the collected UE metrics using the UE traffic profile matrix;
an adjustment module that adjusts a set of UE configurations based on the UE traffic type when one or more predefined conditions are met;
a monitoring module that monitors one or more communication quality metrics after adjusting the set of UE configurations; and
a control module that iterates the determining traffic type procedure and the adjusting UE configurations procedure.

13. The UE of claim 12, wherein the plurality of UE metrics includes one or more elements comprising a uplink/downlink slot duty ratio, a buffer status report, a throughput, a block error rate, and a UE modulation and coding scheme.

14. The UE of claim 12, wherein the plurality of UE metrics includes elements from one or more sources comprising one or more lower layer reports, one or more high layer configuration, and application processor assisted information.

15. The UE of claim 12, wherein the plurality of UE metrics includes both uplink (UL) metrics and downlink (DL) metrics.

16. The UE of claim 15, wherein the set of UE configuration includes one or more TX settings comprising a maximum power reduction (MPR) value, a power amplifier (PA) voltage, a TX antenna number, Transmission antenna selection, Transmission path selection, and a switch setting of a crest factor reduction (CFR)/digital pre-distortion (DPD)/envelope tracking (ET) switch.

17. The UE of claim 15, wherein the set of UE configuration includes one or more RX settings comprising an RX antenna number, receiver mode, coverage enhancement mode, a number of multiple input multiple output search path, dynamic voltage and frequency scaling, and reception antenna selection.

18. The UE of claim 12, wherein each traffic type is preconfigured with a set of corresponding predefined settings for the set of UE configurations.

19. The UE of claim 12, wherein each traffic type is configured with corresponding predefined triggering thresholds to trigger the adjusting UE configurations procedure.

20. The UE of claim 12, wherein the one or more predefined conditions comprises a power-saving trigger when the one or more communication quality metrics being higher than one or more predefined corresponding power-saving thresholds, and a reverting trigger when the one or more communication quality metrics being lower than one or more predefined corresponding reverting thresholds.

21. The UE of claim 20, wherein the adjusting UE configurations procedure adjusts the set of UE configurations to a preconfigured settings based on the traffic type when the power-saving trigger condition is met.

22. The UE of claim 12, wherein the one or more communication quality metrics include block error rate (BLER), signal-to-noise ratio (SNR), transmission power, adjacent channel leakage ratio (ACLR) or error vector magnitude (EVM).
